(19) United States
(12) Patent Application Publication
(10) Pub. No.: US 2018/0103628 A1
(43) Pub. Date: Apr. 19, 2018

(54) Fishing Bait Clasp

(71) Applicants: Wen-Fang Carrie Tung, Rockdale NSW (AU); Johannes Georg Meierhofer, Rockdale NSW (AU)

(72) Inventors: Wen-Fang Carrie Tung, Rockdale NSW (AU); Johannes Georg Meierhofer, Rockdale NSW (AU)

(21) Appl. No.: 15/375,188

(22) Filed: Dec. 12, 2016

(30) Foreign Application Priority Data
Oct. 17, 2016 (AU) 2016244340

(51) Int. Cl. A01K 91/06; A01K 97/00

(52) U.S. Cl. CPC A01K 91/06; A01K 97/00

(57) ABSTRACT

Disclosed is a fishing bait clasp (1) that comprises a circular hollow ring (2) with an internal channel and openable access (3), a side opening (4), a sharp curved pin (5) movable against a tiny spring inside the channel, and 2 small eyes (6 & 7) are soldered on top of the ring for line connection and on the sharp curved pin as access handle. The tiny spring inside the hollow ring puts pressure on the mechanism to keep the access closed. The access can be opened or closed by pushing up and releasing the eye handle along the side of the hollow ring. The sharp curved pin has its sharp head hidden and locked inside the circular hollow ring when closed. The fishing bait clasp provides a new, simple and practical device with flexible methods to be utilised for attaching different universal baits securely for sport fishing.

### TECHNICAL FIELD OF THE INVENTION

The present disclosure generally relates to the field of fishing bait attachment device and more particularly to a fishing bait clasp that provides effective weight support and enhances the function of fishing hooks to secure bait safely during sport fishing.

### BACKGROUND OF THE INVENTION

To prevent fishing bait not losing or falling off from the line before catching targets is always a major challenge for fishermen. Most of fishermen nowadays in sport fishing are still used to attach their bait through a hook as it is an essential tool to catch targets. However the structure of the hook such as barbs may cause trauma in the bait tissue by inserting it through the bait body. Additionally there is not enough weight support for the bait to fall against earth gravity apart from the hook itself. The reasons for that are related to the method of bait attachment, the movability and flexibility of bait on the hook, the total weight support and other unavoidable factors such as casting process or harsh environment. Since no any bait is able to last forever during fishing, the use of fishing tools and the method of attaching bait always play an important role on maintaining the bait securely as long as possible until catching targets.

Despite the prior art and previous disclosures on trying to secure bait with different devices and methods such as wrapping wires or elastic bands around the bait, the expected performances and effects are still not being met properly. The mechanism of the prior art and previous disclosures are tend to fix the bait tightly on the hook and lift up the bait from the connection of the eye of hook as a main central lifting point only instead of sharing its total weight to a few different parts of bait body. The bait may be still tied up on the hook but soon moves downward from the top area of the hook to the bottom area of the hook. It results in the bait getting loosen and loosen on the hook, then easily breaking into pieces or just falling off from the rig after throwing out the line. Moreover the popularity and uses of prior art and previous disclosures are still being influenced by the cost, time, convenience, conception and practicability. Therefore the need for keeping bait securely and safely on the line is still there. The fishing bait clasp is invented to overcome the above disadvantages according to the principles and objects of the present invention described herein.

### SUMMARY OF THE INVENTION

The primary object of the present invention is to provide a fishing bait clasp that secures bait safely and solidly on the hook as long as possible until catching targets.

It is also an important object of the present invention that is to provide a fishing bait clasp that gives extra effectively weight support on holding bait against earth gravity.

A further object of the present invention is to provide a fishing bait clasp that is simple with flexible methods to be applied to most of universal baits including live baits.

A further object of the present invention is to provide a fishing bait clasp that does not distract targets and block the view of bait accessibility by its sizes and attaching methods.

A further object of the present invention is to provide a fishing bait clasp that is economical, convenient, timesaving and effective to be manufactured and used.

A further object of the present invention is to provide a fishing bait clasp that enhances the function of the hook and the method of attaching bait to its maximum.

Use of the fishing bait clasp provides more strength and support on the weight distribution to hold bait solidly on the hook. Multiple uses of the fishing bait clasps are adopted for soft, fragile or larger bait as it provides multiple supports on the weight distribution from different parts of bait body. Additional benefit of the fishing bait clasp is to enable live baits to survive longer with minimal traumas from tools. Furthermore, the present invention does not distract or threaten targets from its size or shape but being considered as a structure which most targets are interested and curious to explore especially when having bait stuck there together. The present invention not only provides a new device for fishermen to flexibly utilise and design their own methods on attaching bait but also maximises the functions of the present invention and standard hook to secure the bait safely on the line as long as possible.

### BRIEF DESCRIPTION OF DRAWINGS

FIG. 1 is a front view of the fishing bait clasp.

FIG. 2 is a front perspective view of the fishing bait clasp half opened.

FIG. 3 is a top perspective view of the fishing bait clasp described herein.

FIG. 4 is a side perspective view of the fishing bait clasp described herein.

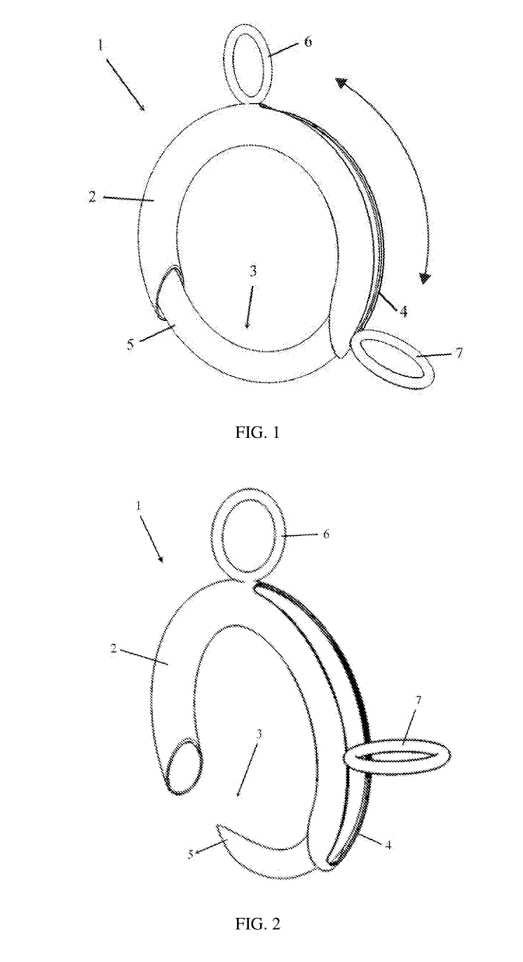

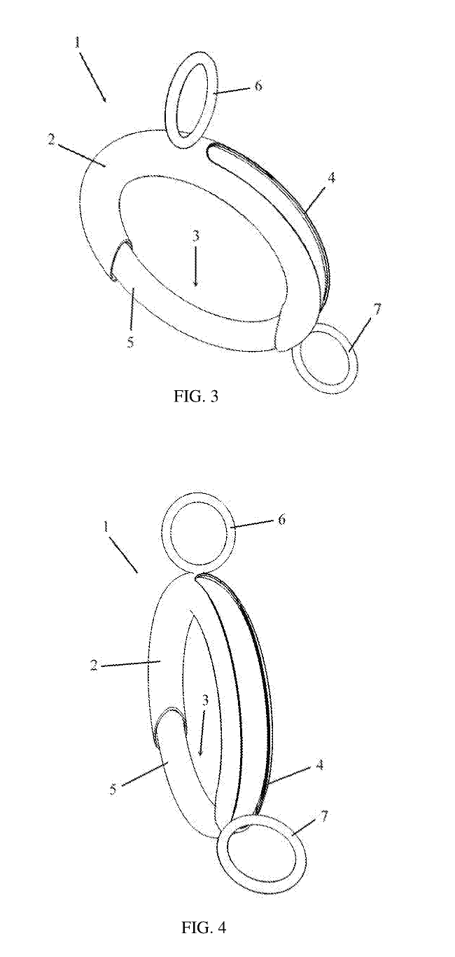

### DESCRIPTION OF EMBODIMENTS

The description of embodiments of the present invention includes a fishing bait clasp that is constructed in accordance with the principles and objects described herein.

The fishing bait clasp comprises a circular hollow ring with an internal channel, an openable access on the bottom section, a side opening along one side of hollow ring, a sharp curved pin movable against a tiny spring inside the internal channel to control its access through the side opening of the hollow ring, and 2 small eyes soldered on the top edge of the circular hollow ring for the connection of main line and on the sharp curved pin for the use as access handle. The bait clasp has at least ⅓-¼ of its circumference designed for the openable access and side opening. The access can be opened or closed by pushing up and releasing the eye handle along the side of the hollow ring. The tiny spring inside the clasp puts pressure on the mechanism to keep the access of the clasp closed. The sharp curved pin is made longer than the distance of the access and its sharp head is hidden and locked inside the circular hollow ring when closed. The fishing bait clasp locks bait and hook together in the access area by piercing its sharp pin through both and closing the access. The diameter of the sharp curved pin is made smaller than the diameter of the ring channel so as to fit in and perform its function properly inside the hollow ring. The 2 small eyes may be alternatively made in round or oval shape and are perpendicularly or horizontally soldered on one side of the access used as handle and on top of bait clasp for the connection to the main line. The fishing bait clasp is made of metal material and may be made in a number of different sizes to fit different types and sizes of baits.

One simple example and method on the use of the present invention is to attach a bait clasp and a standard hook onto a squid bait. The bait clasp and the standard hook are attached on the lower body of the squid bait with its head sitting on the bend of the hook. The method for the example is to insert a standard hook from the middle body of the squid bait to its head first. Then pulling its lower body up towards top with finger pressure and then apply the bait clasp into the eye of the hook and the lower body of the squid. The bend of the hook inside the squid head and the bait clasp provide 2 different lifting points to support the total weight of the squid bait. The last step is to connect the bait clasp to the top main line.

Another example and method on the use of the present invention is to attach one bait clasp and one standard hook onto a live blood worm. The attaching method is to have the bait clasp inserted into the eye of a hook first, then using the sharp point of the hook to stick through the worm from its upper section of body towards its neck. The head section is therefore sitting on the bend of the hook. The next step is to wrap the rest of the worm body upwards along the shank of the hook and have it gone through the circular enclosed section of the bait clasp to the other side. Then pull the worm body to wrap downwards along the shank of the hook with a bit finger pressure until reaching the sharp point of the hook and having its lower body inserted through the sharp point to be located on top of its head. The last step is to connect the bait clasp from its top eye to the main line setting. The supporting points for the live worm are the bend and shank of the hook as well as the lifting point from the sharp curved pin of the bait clasp. The blood worm is therefore well supported on its total weight towards earth gravity and has no possibility to escape or fall apart from wriggling around on the hook.

Another example and method on the multiple uses of the present invention is to apply two fishing bait clasps and two standard hooks onto a pilchard bait. The 1^{st} bait clasp and one standard hook are clamped in the upper body section of the pilchard bait. The 2^{nd} bait clasp and the other standard hook are clamped in the middle section of the bait body. The method for the attachment is to insert one standard hook through the upper body of pilchard bait with the eye of the hook placed on its head section first, then holding and pulling up the shank of the hook towards the top with a bit finger pressure. Then apply the bait clasp by piercing the sharp curved pin into the eye of the standard hook and pilchard head together. The other standard hook and the 2^{nd} bait clasp are attached on the middle section of pilchard body with the same application as on the head. Using a fishing line ties both bait clasps together with tight knots. This way provides effective supports on holding the pilchard bait by the lifting points of the bends of the hooks, the accesses of the bait clasps and the connection points of both bait clasps. It also prevents the pilchard body breaking down quickly as the needle stick injures in the body tissue of pilchard bait from the clasps and hooks are compressed tightly by the finger pressure and from the connecting process. Another additional function of the 2 bait clasps on the pilchard head and body may partly avoid its body being directly rubbed or damaged from the surface abrasion when trolling the line back.

According to the objects, illustrations and examples mentioned above, it can be seen that the present invention provides various and flexible methods to be used on most of universal baits including live baits by adding the fishing bait clasp during the process or in the last step of attaching bait. It also can be seen that the present invention provides extra effective strength and support on the weight distribution of bait. From its design, mechanism to its methods, it reveals that the present invention is novel and different to the prior art and previous disclosures as it provides a new, simple, universal, practical and cost effective device with flexible methods to be utilised for attaching different types and sizes of baits securely for sport fishing.

1. A fishing bait clasp comprises:
a circular hollow ring with an internal channel, an openable access and a side opening;
a sharp curved pin movable against a tiny spring inside the internal channel; and
two small eyes are soldered on one side of access as access handle and on top of the hollow ring for the connection to the main line.

2. The fishing bait clasp recited in claim 1, wherein said
the fishing bait clasp is made of metal material.

3. The fishing bait clasp recited in claim 1, wherein said
the circular hollow ring has at least ⅓-¼ of its circumference spaced for the openable access and side opening.

4. The fishing bait clasp recited in claim 1, wherein said
the sharp curved pin has a sharp head on one side and its sharp head is hidden and locked inside the circular hollow ring when closed.

5. The fishing bait clasp recited in claim 1, wherein said
the sharp curved pin is made smaller than the diameter of the ring channel so as to fit in and operate its function properly inside the hollow ring.

6. The fishing bait clasp recited in claim 1, wherein said
the tiny spring inside the internal channel against the sharp curved pin puts pressure on the mechanism to control the access of the clasp opening or closing by pushing up and releasing the eye handle along the side opening of the hollow ring.

7. The fishing bait clasp recited in claim 1, wherein said
at least two small eyes are made alternatively in round or oval shape, and soldered either perpendicularly or horizontally on one side of the bait clasp as access handle and on top for the connection to the main line.

8. The fishing bait clasp recited in claim 7, wherein said
the two small eyes are made at least slightly larger than the diameter of sharp curved pin for the combined use of other bait clasps or devices.

9. The fishing bait clasp recited in claim 1, wherein said
the fishing bait clasp locks bait and hook together in the access area by piercing its sharp pin through both and closing the access.

10. The fishing bait clasp recited in claim 1, wherein said
the fishing bait clasp is made in a number of different sizes to fit various types and sizes of baits.
